(19) United States
(12) Patent Application Publication
(10) Pub. No.: US 2011/0043518 A1
(43) Pub. Date: Feb. 24, 2011

(54) Techniques to store and retrieve image data

(76) Inventors: Nicolas Galoppo Von Borries, Portland, OR (US); William A. Hux, Hillsboro, OR (US); David Bookout, Portland, OR (US)

Correspondence Address: INTEL CORPORATION;c/o CPA Global, P.O. BOX 52050, MINNEAPOLIS, MN, 55402, US

(21) Appl. No.: 12/583,554

(22) Filed: Aug. 21, 2009

(51) Int. Cl. G06T 15/00

(52) U.S. Cl. 345/419

(57) ABSTRACT

In a graphics pipeline, during or at the end of a rasterization stage, a post-clip output stage stores primitives and pixels are stored in a portion of memory. Availability of primitives and pixels during or at the end of the rasterization stage permits a variety of manners in which to process primitives and pixels.

### FIELD

The subject matter disclosed herein relates generally to techniques to store and retrieve image data.

### RELATED ART

The demands for graphics processing are evident in areas such as computer games, computer animations, and medical imaging. The graphics pipeline is responsible for rendering graphics. Numerous graphics pipeline configurations are known. For example, popular rendering pipeline architectures are described in Segal, M. and Akeley, K., “The OpenGL Graphics System: A Specification (Version 2.0)” (2004) and The Microsoft DirectX 9 Programmable Graphics Pipe-line, Microsoft Press (2003). The contemporary pipeline has three programmable stages, one for processing vertex data (e.g., a vertex shader), a second one for processing geometric primitives (e.g. a geometry shader), and a third one for processing pixel fragments (e.g., a fragment or pixel shader). Microsoft® DirectX 10 introduced geometry shaders and a geometry stream-out stage. An overview of the Direct3D 10 System is provided in D. Blythe, “The Direct3D 10 System,” Microsoft Corporation (2006). DirectX is a group of application program interfaces (APIs) involved with input devices, audio, and video/graphics.

### BRIEF DESCRIPTION OF THE DRAWINGS

Embodiments of the present invention are illustrated by way of example, and not by way of limitation, in the drawings and in which like reference numerals refer to similar elements.

FIG. 1 depicts an example of a graphics processing pipeline in block diagram format, in accordance with an embodiment.

FIG. 2 depicts an example of a conventional pixel shader processing of pixel coverage masks as well as processing of pixel coverage masks in a tile according to various embodiments.

FIG. 3 depicts an example of core utilization when a single core processes tiles and core utilization before and after distribution of processing of a single tile to multiple cores.

FIG. 4 depicts examples of customized rasterization processing of primitives and pixel coverage masks.

FIG. 5 depicts a flow diagram of a manner of storing primitives and pixel coverage masks in a buffered mode, in accordance with an embodiment.

FIG. 6 depicts a flow diagram of a manner of retrieving primitives and pixel coverage masks in a buffered mode, in accordance with an embodiment.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Various embodiments provide a manner of storing primitive properties and pixel coverage information during or after a rasterization stage in a graphics pipeline. A post-clip stream output stage employs portions of buffers in memory to store primitives and pixel coverage masks related to the primitives. Sub-regions of the screen, known as tiles, are spatially coherent collections of pixel data in screen space. The primitives are ordered per tile and clipped to the tile boundaries, optionally with pixel coverage masks. Pixel coverage masks identify a relationship of a pixel with a primitive. For example, the pixel coverage mask may identify whether a pixel is within a primitive, outside primitive, or on the edge of a primitive. The stored primitives and pixel coverage information can be read-out and processed in a variety of manners. For example, pixel coverage masks related to the same tile can be read out in parallel or in a sequence and the pixel coverage masks related to the same tile can be processed together. Pixel processing can be performed on pixel coverage masks associated with the same tile so that processed data can be reused for pixel coverage masks where possible.

DirectX 10 specifies generating clipped triangle data in a geometry shader. DirectX10 only exposes covered pixel coverage masks in a scalar mode in the pixel shader. By contrast, various embodiments make per-primitive pixel coverage masks available for processing entire tiles in parallel, by Single Instruction, Multiple Data (SIMD) vectorized code or by running tasks in parallel over multiple cores or threads.

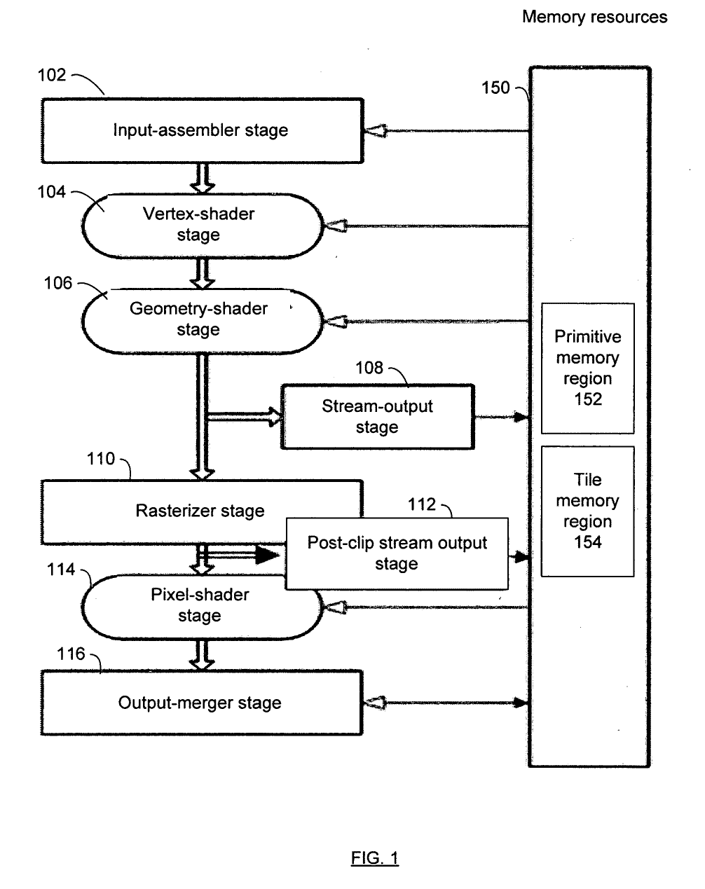

FIG. 1 depicts an example of a graphics processing pipeline 100 in block diagram format, in accordance with an embodiment. In various embodiments, pipeline 100 is programmable at least based on Microsoft's DirectX 10 or OpenGL 2.1. In various embodiments, all stages can be configured using one or more application program interfaces (API). Drawing primitives (e.g., triangles, rectangles, squares, lines, point, or shapes with at least one vertex) flow in at the top of this pipeline and are transformed and rasterized into screen-space pixels for drawing on a computer screen.

Input-assembler stage 102 is to collect vertex data from up to eight vertex buffer input streams. Other numbers of vertex buffer input streams can be collected. In various embodiments, input-assembler stage 102 may also support a process called “instancing,” in which input-assembler stage 102 replicates an object several times with only one draw call.

Vertex-shader (VS) stage 104 is to transform vertices from object space to clip space. VS stage 104 is to read a single vertex and produce a single transformed vertex as output.

Geometry shader stage 106 is to receive the vertices of a single primitive and generate the vertices of zero or more primitives. Geometry shader stage 106 is to output primitives and lines as connected strips of vertices. In some cases, geometry shader stage 106 is to emit up to 1,024 vertices from each vertex from the vertex shader stage in a process called data amplification. Also, in some cases, geometry shader stage 106 is to take a group of vertices from vertex shader stage 104 and combine them to emit fewer vertices.

Stream-output stage 108 is to transfer geometry data from geometry shader stage 106 directly to a portion of a frame buffer in memory 150. After the data moves from stream-output stage 108 to the frame buffer, data can return to any point in the pipeline for additional processing. For example, stream-output stage 108 may copy a subset of the vertex information output by geometry shader stage 106 to output buffers in memory 150 in sequential order.

Rasterizer stage 110 is to perform operations such as clipping, culling, fragment generation, scissoring, perspective dividing, viewport transformation, primitive setup, and depth offset. In addition, rasterization stage 110 can perform any or all of: associating screen-space primitives with tiles (e.g., sub-regions of the screen) for parallelized processing; clipping of the primitives to the extents of the tiles (or the entire screen viewport in case of a single tile); generating pixel coverage masks, which are lists of the pixels that are touched by the primitives in each tile; and/or generating interpolated values of surface and material properties for each touched pixel.

Rasterizer stage 110 is to provide at least one output stream. The output stream includes two sub-streams: one sub-stream for primitives and one sub-stream for pixel coverage masks. The sub-streams can be output at different rates. The streamed data can be consumed independently for each rasterized tile as soon as it becomes available. This is advantageous in multi-threaded environments where work can be assigned to different threads and processed in parallel while the stream data for other tiles is still being generated in the graphics pipeline.

In relation to a pipeline ordered processing of pixels, post-clip stream-output stage 112 is positioned in the pipeline after rasterization stage 110 and before the pixel shading stage 114. Post-clip stream-output stage 112 is to store a primitive stream into a portion of primitive memory region 152 and store pixel coverage masks into a portion of tile memory region 154. In some cases, pixel coverage masks generated by rasterization stage 110 are not stored in memory region 154. In such case, memory region 154 is not allocated.

In various embodiments, the primitive stream includes clipped screen-space primitives and is in draw order, but not necessarily grouped per tile. The primitive stream includes screen-space vertex positions of the primitives as well as per-vertex depth information for custom interpolation. Other per-vertex properties for primitives include texture coordinates, color, lifespan, radiance, irradiance, and depth and those properties can be included in the stream as well, depending on the application requirements for memory footprint, features and performance.

In various embodiments, the pixel coverage stream references the primitives and is grouped per clipped-primitive. The pixel coverage masks define which screen pixels are touched by the corresponding primitive. In some embodiments, this pixel coverage mask stream is not stored. Instead, custom application-side coverage mask generating code generates the pixel coverage masks. An application that generates pixel coverage masks knows the vertex positions of the primitives and determines whether a pixel is associated with a primitive based on the vertex positions. Such application could allocate a buffer in memory 150 to store pixel coverage masks into the allocated region in memory.

In various embodiments, post-clip stream-output stage 112 is to store primitive data and optionally pixel coverage data in a variable-size memory buffer, either in a streaming mode or buffered mode with a linked-list representation that enables sequential consumption in draw-order of the primitive and pixel coverage streams. If pixel coverage masks are generated, then a coverage stream data structure contains a pointer to the data structure of its associated primitive in the primitive stream.

In the streaming mode, primitive data is processed by an application in a per-tile call-back function. In streaming mode, only parts of the stream (e.g., size of a tile) are available to the application at once. In the streaming mode, the primitive and pixel coverage data can be overwritten after processing. After the application is done processing that tile-sized part of the stream, the part of the stream is available to be overwritten. This mode consumes less memory, enables processing data as soon as it is ready in a multi-threaded environment, but does not enable work sharing across tiles.

In buffered mode, data for the whole screen is stored in a buffer and accessible by an application after the whole stream (e.g., all tiles or a specific number or region of tiles) is generated. Accordingly, in buffered mode, the pixel coverage masks of all tiles of a frame are stored in tile memory region 154. Tile memory region 154 is filled by post-clip output stage 112 and the pixel coverage masks of tiles of a frame are available for processing if pixel coverage masks of all tiles of a frame are stored or the tile memory region 154 is filled. One or more applications can then subsequently process all the data at once.

In both streaming and buffered modes, the data is streamed out to a memory resource managed on the graphics pipeline and is not directly programmable and not directly accessible to the application. The data can be processed on the application side in a per-tile call-back function. The data can be streamed back into the pipeline in a subsequent rendering pass without intervention of the application side or copied to a staging resource so it can be read by the application asynchronously. The graphics pipeline is free to schedule the generation of the data stream in any manner because the graphics pipeline knows about the managed stream memory resource dependencies. A memory resource dependency may occur if the stream-out data is used in a subsequent rendering pass or if the data can be discarded after the application has processed it. In the buffered mode, an application can access the data by either requesting a lock on the resource or an asynchronous copy.

Pixel shader stage 114 is to read the properties of each single pixel fragment and produce an output fragment with color and depth values.

Output merger stage 116 is to perform stencil and depth testing on fragments from pixel shader stage 114. In some cases, output merger stage 116 is to perform render target blending.

Memory 150 can be implemented as any or a combination of: a volatile memory device such as but not limited to a Random Access Memory (RAM), Dynamic Random Access Memory (DRAM), Static RAM (SRAM), or any other type of semiconductor-based memory or magnetic memory.

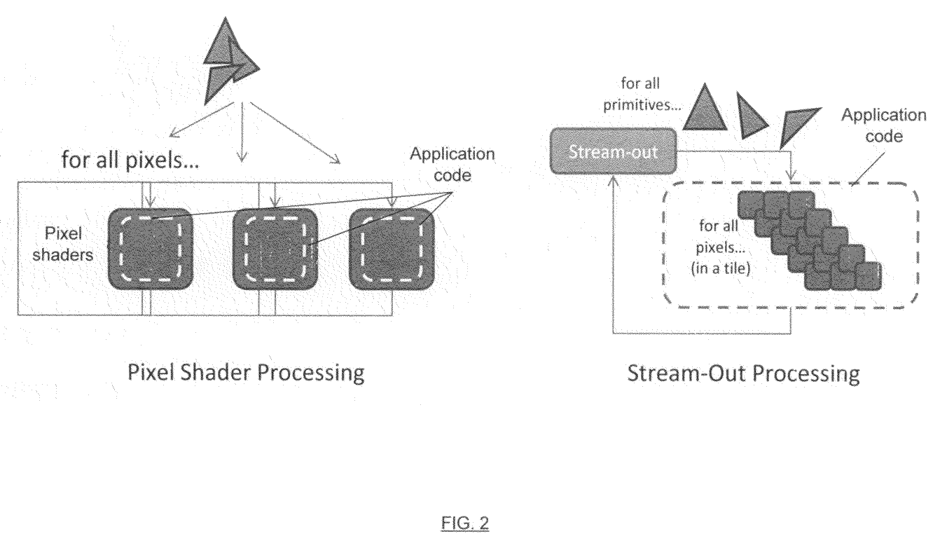

FIG. 2 depicts an example of a conventional pixel shader processing of pixels as well as processing of pixels in a tile according to various embodiments. For conventional pixel shader processing in known graphics pipelines, pixels from primitives are distributed over multiple pixel shaders for processing. However, in various embodiments, pixels related to the same tile are available for processing. Processing of pixels related to the same tile may provide some advantages over processing of pixels by conventional pixel shaders, but such advantages are not required features of any embodiment. First, many computations that are common to a single primitive can be pre-computed and re-used for all pixels within the tile. Examples of such computations are interpolation matrices for inside-triangle tests and early-out strategies. Second, per-primitive processing offers the flexibility of communicating adjacent pixel data and thereby enables screen-space effects such as bloom and depth-of-field at the application side.

In known graphics pipelines, tile processing is restricted to a single core in the geometry or pixel shader. However, various embodiments permit multiple cores to process primitives and pixels of a tile in parallel. In various embodiments, availability of primitives and pixels after rasterization permits tiled processing of primitives such as processing of subregions of picture. In addition, availability of primitives and pixels after rasterization permits the ability to parallelize and redistribute work on the application side. For example, multiple cores can process primitives and pixels in parallel. As a result, availability of primitives and pixels after rasterization enables considerable performance improvements compared to conventional graphics pipelines.

Tile-ordered access patterns enable significant performance advantages for many graphics processing technique that tend to have spatial coherency in screen space. Such ordering enables optimal use of the graphics cache and avoids cache misfetch performance penalties.

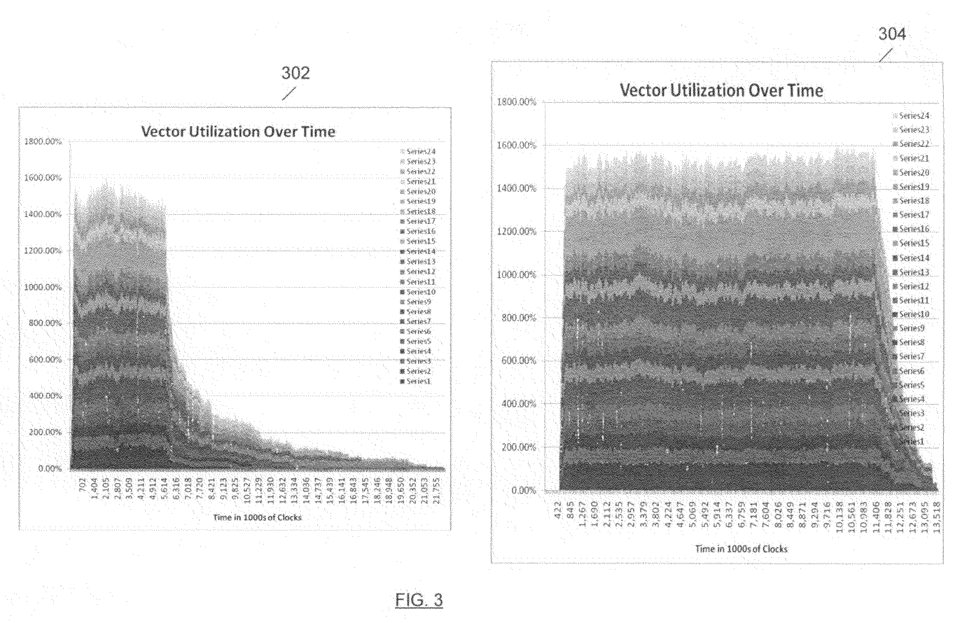

FIG. 3 depicts an example of core utilization when a single core processes tiles and core utilization after distribution of processing of a single tile to multiple cores. The diagrams represent vector utilization over time. Diagram 302 shows the work for each tile is restricted to a single core. Some cores quickly go idle while others are still processing for work-intensive tiles. Diagram 304 shows the work of those tiles is redistributed across multiple cores to achieve much better core utilization over time.

In various embodiments, availability of primitives and pixels after rasterization enables customized processing of primitives and pixel coverage masks. A call-back routine can be called each time a portion of screen is to be rendered. An example call-back routine is a tile rendering operation. In the streaming mode, new graphics features and effects can be added by adding code in the call-back routine that implements the customized rasterization processing of primitives and pixels.

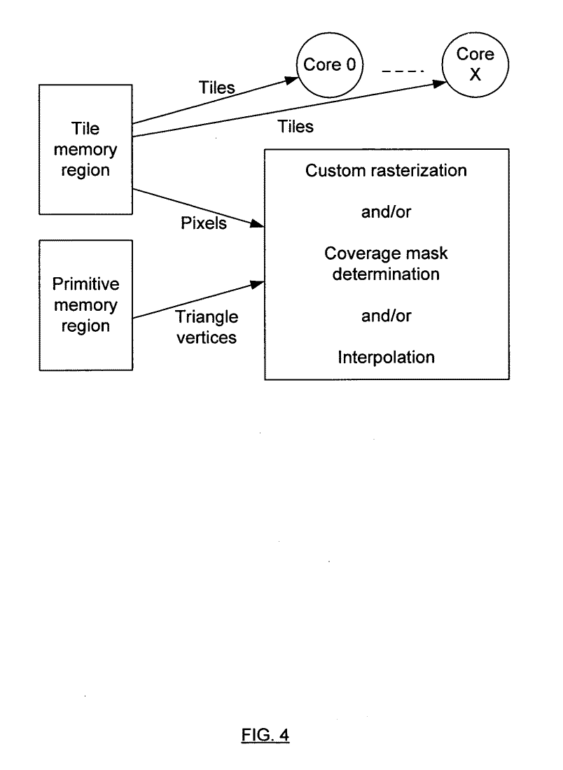

FIG. 4 depicts examples of customized rasterization processing of primitives and pixels. For example, customized rasterization processing can include irregular rasterization. Irregular rasterization includes rasterization that makes use of non-2D grid data structure in rendering images. For example, for irregular rasterization and shadowing applications, the application can implement custom interpolation techniques because the primitive-specific surface and material properties are provided per-screen-vertex and because primitive vertex values are available for use. Custom interpolation may include determining surface property values at off-center pixel locations based on primitive vertex values. This primitive vertex data is not available in conventional pixel shaders, as they are only provided with interpolated values at the center of the pixel. The custom interpolation is done by the application that uses stream-out, and hence those results may be used by the application, not the graphics pipeline.

As a second example, the application can choose to forgo regular coverage mask computation in the rasterizer and instead compute custom coverage masks. A coverage mask is a mask defines which pixels are touched by a primitive. For example, a designer could determine what rules to apply to determine whether a pixel touches a primitive. For example, a custom coverage mask may allow a primitive to touch a pixel if the pixel barely touches a primitive but is not inside the primitive. The application can use those custom coverage masks.

An irregular Z buffer is described in the article, Gregory S. Johnson, William R. Mark, and Christopher A. Burns, “The Irregular Z-Buffer and its Application to Shadow Mapping,” The University of Texas at Austin, Department of Computer Sciences, Technical Report TR-04-09. In FIG. 3 of the article, the yellow dots indicate the locations within a pixel where attributes of the primitive such as color and depth are computed. This computation is called “interpolation.” With reference to FIG. 3 of the paper, in the classic graphics pipeline, depth is computed at the pixel centers. By contrast, for an irregular Z buffer, depth (also known as “Z”) is determined at arbitrary locations. In various embodiments, storage of primitives and pixel coverage masks allows for applications to interpolate at arbitrary locations, which is used in implementations of an irregular Z buffer.

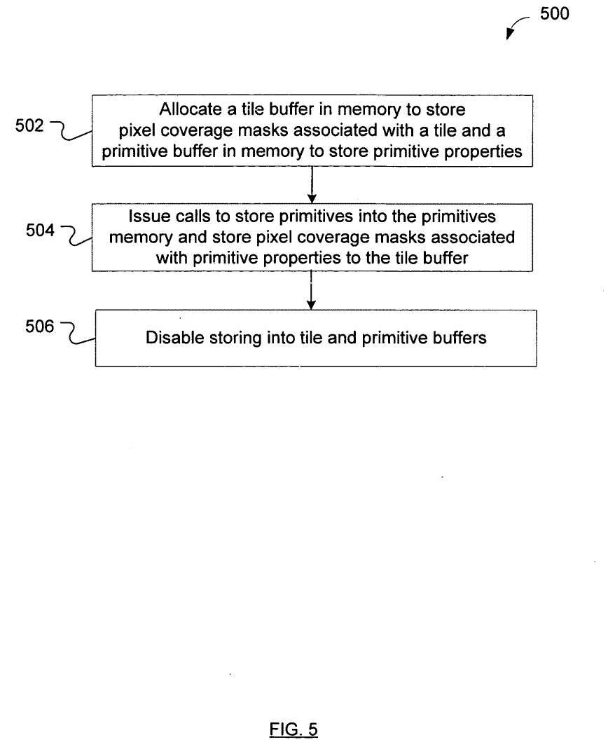

FIG. 5 depicts a flow diagram of a process 500 depicting a manner of storing primitives and pixels in a buffered mode, in accordance with an embodiment. The process of FIG. 5 can be performed by a processor-executed application. Block 502 includes allocating a tile buffer in memory to store pixel coverage masks associated with a tile and a primitive buffer in memory to store primitives. Block 502 does not need to be performed in cases where the application is to generate custom pixel coverage masks. For example, allocating a tile buffer in memory to store pixel coverage masks associated with a tile may not be performed in cases where the application is to generate custom pixel coverage masks. In cases where the application is to generate custom pixel coverage masks, the application may allocate a buffer to store the custom pixel coverage masks. For example, a tile can be a 4×4 pixel region. For example in the pseudo code below, instruction SetFrontEndSOTargets allocates the buffers.

Block 504 includes issuing calls to store primitive properties from a rasterizer into the primitives buffer and store pixel coverage masks associated with primitives from a rasterizer into the tile buffer. Issuing calls to store pixel coverage masks associated with primitives from a rasterizer into the tile buffer may not be performed in cases where the application is to generate custom pixel coverage masks.

Block 506 includes disabling storing pixel coverage masks and primitive properties into allocated buffers. For example in the pseudo code below, instruction FrontEndSOSetTargets disables storing into allocated buffers. Disabling storing pixel coverage masks into allocated buffers may not be performed in cases where the application is to generate custom pixel coverage masks.

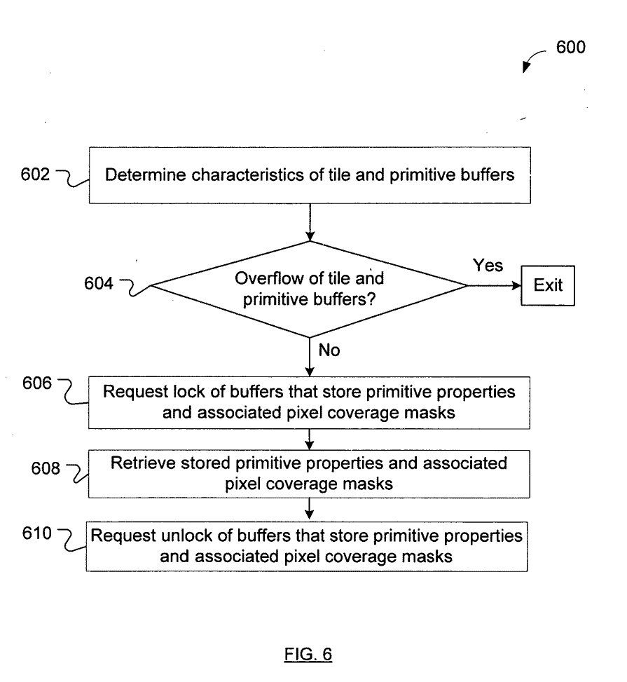

FIG. 6 depicts a flow diagram of a process 600 depicting a manner of accessing primitive properties and pixel coverage masks, in accordance with an embodiment. Process 600 can be executed by a host-side application. Block 602 includes determining characteristics of primitive properties and tile buffers. For example, block 602 may include retrieving an overflow flag associated with each buffer and determining a number of tiles stored in the tile buffer. In the pseudo code below, instruction Query_GetData retrieves the overflow flag.

Block 604 includes determining whether an overflow of the tile and primitive buffers takes place. For example, block 604 may include identifying overflow of the buffers based on the overflow flag. If an overflow is detected, the process can exit. In various embodiments, the process may ask for additional memory in tile and primitive buffers so that overflow of such buffers does not take place. The additional memory may be more than that allocated for the overflowed buffers. For example, the additional memory may allow for storage of more tiles than are stored in the tile buffer and storage of more primitives than are stored in the primitive buffer. For example in the pseudo code below, instruction SetFrontEndSOTargets allocates the size of the buffers. Accordingly, in a next execution of instruction SetFrontEndSOTargets, the size of the buffers can be changed.

Block 606 includes requesting a memory lock of buffers or portions of buffers that store primitive properties and associated pixel coverage masks. A memory lock may involve excluding other processes from overwriting the data in the buffers of interest. In the pseudo code below, instruction ViewLock causes locking of a portion of a tile buffer.

Block 608 includes retrieving stored primitive properties and associated pixel coverage masks. Retrieved primitive data can be released for processing in any manner. For example, the processes described with regard to FIG. 4 can process the primitive and pixel data.

Block 610 includes releasing the memory lock of the portion of the buffer that was locked. In the pseudo code below, instruction ViewUnlock releases the locked portion of the buffer so that the buffer can be read from or written to by other processes.

Pseudo code for a manner of storing primitives and pixels (FIG. 5) and accessing stored primitives and pixels (FIG. 6) is provided below.

```
/////////////////////////////////////////////////////////////////////////////////////////
// 1. Initialization
// These resources are handles to the streams, just like normal Omatic resources
OMATIC_RESOURCE_HEADER mTriangleStream;
OMATIC_RESOURCE_HEADER mQQuadStream;
// Mode #1 -- Static mode, allocate buffer from user side, stop filling when out of
memory
OM_U32x dataSize = ...
void * data = ArchAlignedMalloc(dataSize, CACHE_LINE_SIZE);
OMATIC_FORMAT format = OMATICFMT_STATIC_STREAMDATA;
OM_U32 flags = OMATIC_BIND_STREAM_OUTPUT |
OMATIC_BIND_CPU_READ;
Omatic_ResourceInitBuffer(mpDev, &mTriangleStream, data, pitch, dataSize,
format, flags);
Omatic_ResourceInitBuffer(mpDev, &mQQuadStream, data + offset, pitch,
dataSize, format, flags);
// Mode #2 -- Dynamic mode, let Omaha manage growing buffer
OMATIC_FORMAT format = OMATICFMT_DYNAMIC_STREAMDATA;
Omatic_ResourceInitBuffer(mpDev, &mTriangleStream, NULL, 0, 0, format,
flags);
Omatic_ResourceInitBuffer(mpDev, &mQQuadStream, NULL, 0, 0, format,
flags);
/////////////////////////////////////////////////////////////////////////////////////////
// 2. Render time
// Enable front-end streamout (static or dynamic )
Omatic_SetFrontEndSOTargets(mpDev, &mTriangleStream, &mQQuadStream);
Omatic_Draw(...);
Omatic_Draw(...);
// Disable
Omatic_FrontEndSOSetTargets(mpDev, 0, 0); // optional
/////////////////////////////////////////////////////////////////////////////////////////
// 3. Read-back of the output stream
Omatic_ViewsSubresourcesEnsureRenderingFinished(mpRenderTarget-
>pFullView);
OMATIC_QUERY_SO_STATISTICS stats;
Omatic_Query_GetData(&stats); // Do we need a begin/end query at render
time?
assert(!stats.Overflow);
Omatic_ViewLock(mTriangleStream.pFullView, 0, 0);
Omatic_ViewLock(mQQuadStream.pFullView, 0, 0);
{
  const OMAHA_STREAMOUT_TRIANGLE *triangleData =
    (const OMAHA_STREAMOUT_TRIANGLE *) mTriangleStream.pData;
  const OMAHA_STREAMOUT_QQUAD *quadData =
    (const OMAHA_STREAMOUT_QQUAD *) mQQuadStream.pData;
  const OMAHA_STREAMOUT_QQUAD *qq = quadData;
  for (OM_U64 i = 0; i < stats.QQuadCount; ++i)
  {
    OMAHA_STREAMOUT_TRIANGLE *curTriangle = triangleData[qq-
>TIndex];
    dprintf(“QQ: T#%d, %d %d M:%x\n”, qq->TIndex, qq->X, qq->Y, qq->Mask);
    ++qq;
  }
}
Omatic_ViewUnlock(mQQuadStream.pFullView, 0);
Omatic_ViewUnlock(mTriangleStream.pFullView, 0);
/////////////////////////////////////////////////////////////////////////////////////////
// Function Signatures
/////////////////////////////////////////////////////////////////////////////////////////
/** \brief Set the frontend (post-clipping) streamout pointers. Implies no backend
processing is required.
*
* Set the pointers to NULL in order to turn on normal rendering.
*
* \param pDev is the ::OMATIC_DEVICE this call affects.
* \param pTriangleSOTarget is a streamout buffer resource receiving the clipped
(screen-space) triangles
* \param pQQuadSOTarget is a streamout buffer resource receiving the quad
stream
*/
void Omatic_SetFrontEndSOTargets(OMATIC_DEVICE *pDev,
```

OMATIC_RESOURCE_HEADER *pTriangleSOTarget,
OMATIC_RESOURCE_HEADER *pQQuadSOTarget
//void * pfOverflowFunction
);

// stream data format
typedef struct _OMAHA_STREAMOUT_SCREEN_VERTEX
{

| | | |
|---|---|---|
| OM_FIX8 | XX; | // signed 24.8 |
| OM_FIX8 | YY; | // signed 24.8 |
| OM_F32 | ZZ; | |

} OMAHA_STREAMOUT_SCREEN_VERTEX;
typedef struct _OMAHA_STREAMOUT_INTERPOLANT
{

| | |
|---|---|
| OM_F32 | AA; |
| OM_F32 | BB; |
| OM_F32 | CC; |

```
} OMAHA_STREAMOUT_INTERPOLANT;
typedef struct _OMAHA_STREAMOUT_TRIANGLE
{
  OMAHA_STREAMOUT_SCREEN_VERTEX V[3];
  OMAHA_STREAMOUT_INTERPOLANT Z;
} OMAHA_STREAMOUT_TRIANGLE;
typedef struct _OMAHA_STREAMOUT_QQUAD
{
  OM_U32x TIndex;
  OM_U16 Mask;
  OM_U8 X;
  OM_U8 Y;
} OMAHA_STREAMOUT_QQUAD;
```

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device such as a portable mobile computer or mobile telephone with a display device to display images or video processed by the graphics pipeline.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A computer-implemented method comprising:
allocating a portion of a first buffer in memory to store primitive properties;
request storing the primitive properties from a rasterizer into a portion of the first buffer; and
permitting access to the primitive properties by an application independent from a graphics pipeline.

2. The method of claim 1, wherein the primitive properties comprise screen-space vertex positions and per-vertex depth information.

3. The method of claim 2, wherein the primitive properties further comprise identification of clipped tile boundaries.

4. The method of claim 1, wherein the primitive properties comprise a per-vertex property selected from at least one of:
texture coordinates, color, lifespan, radiance, and irradiance.

5. The method of claim 1, wherein the primitive properties comprise draw order.

6. The method of claim 1, further comprising:
requesting receipt of pixel coverage masks associated with the primitive properties from the rasterizer;
allocating a portion of a second buffer in memory to store pixel coverage masks associated with the primitive properties; and
requesting storing of pixel coverage masks into the portion of the second buffer.

7. The method of claim 6, wherein at least one of the stored pixel coverage masks identifies a relationship of at least one pixel with a primitive.

8. The method of claim 1, further comprising:
permitting access to primitive properties and
permitting an application to generate pixel coverage masks based on selected primitive properties, wherein the selected primitive properties comprise vertex position and depth.

9. The method of claim 8, wherein the pixel coverage masks identify whether a pixel is within a primitive, outside primitive, or on the edge of a primitive.

10. The method of claim 1, further comprising:
permitting access to tiles of pixel coverage masks for processing by multiple cores in parallel.

11. The method of claim 1, further comprising:
permitting an application to interpolate color and depth of a pixel at a location outside the pixel's center based in part on primitive vertex properties selected from among color, depth, and coordinates.

12. An apparatus comprising:
a memory;
a graphics pipeline comprising at least a rasterizer and a post-clip stream output stage; and
a processor-executed application to:
allocate a portion of a first buffer in the memory to store primitive properties from the rasterizer,
request the post-clip stream output stage to store the primitive properties into a portion of the first buffer, and
permit access to the primitive properties by a second processor-executed application.

13. The apparatus of claim 12, wherein the primitive properties comprise screen-space vertex positions and per-vertex depth information.

14. The apparatus of claim 13, wherein the primitive properties identify clipping to tile boundaries.

15. The apparatus of claim 12, wherein the primitive properties comprise a per-vertex property selected from at least one of:
texture coordinates, color, lifespan, radiance, and irradiance.

16. The apparatus of claim 12, wherein the second application is to:
request receipt of pixel coverage masks associated with the primitive properties from the rasterizer;
allocate a portion of a second buffer in memory to store pixel coverage masks associated with the primitive properties; and
request storing of pixel coverage masks into the portion of the second buffer.

17. The apparatus of claim 16, wherein the pixel coverage mask identifies a relationship of at least one pixel with a primitive.

18. The apparatus of claim 12, wherein the second application is to:
generate pixel coverage masks based on selected primitive properties, wherein selected primitive properties comprise vertex position and depth.

19. The apparatus of claim 18, wherein the pixel coverage masks identify whether a pixel is within a primitive, outside primitive, or on the edge of a primitive.

20. The apparatus of claim 12, wherein the second application is to:
allocate pixel coverage masks for processing by multiple cores in parallel.

21. The apparatus of claim 12, wherein the second application is to:
interpolate color and depth of a pixel at a location outside the pixel's center based in part on primitive properties selected from among color, depth, and coordinates.

22. A system comprising:
a display and
a computer system comprising:
a graphics pipeline capable of processing images or video for rendering by the display, wherein the graphics pipeline comprises at least a rasterizer and a post-clip stream output stage and
logic to:
allocate a portion of a first buffer in memory to store primitive properties from the rasterizer and
request the output stage to store the primitive properties into a portion of the first buffer.

23. The system of claim 22, wherein the primitive properties comprise screen-space vertex positions and per-vertex depth information.

24. The system of claim 22, wherein the stored primitive properties comprise a per-vertex property selected from at least one of:
texture coordinates, color, lifespan, radiance, and irradiance.

25. The system of claim 22, further comprising logic to perform at least one of:
generate pixel coverage masks based on selected primitive properties, wherein selected primitive properties comprise vertex position and depth and
allocate pixel coverage masks for processing by multiple cores in parallel.
